(19) United States
(12) Patent Application Publication
(10) Pub. No.: US 2021/0303651 A1
(43) Pub. Date: Sep. 30, 2021

(54) Content Discovery Using Topic Stacks

(71) Applicant: Platstack, LLC, South Jordan, UT (US)

(72) Inventor: Eslee Buckley Barlow, Bluffdale, UT (US)

(21) Appl. No.: 16/830,240

(22) Filed: Mar. 25, 2020

(51) Int. Cl. G06F 16/955; G06F 16/9532; G06F 16/954; G06F 16/958

(52) U.S. Cl. CPC G06F 16/9566; G06F 16/9532; G06F 16/986; G06F 16/954; G06F 16/9558

(57) ABSTRACT

Technology is described for finding content related to a uniform resource identifier (URI). A source URI that is displayed in a tab of a browser may be received. The source URI may be sent as a query to a query engine. The query may be made against a data store containing a plurality of URI groupings forming topic stacks, and individual topic stacks may be described using a topic description to provide topical context for the plurality of URIs. A plurality of topic descriptions for topic stacks may be received from the query engine. The plurality of topic descriptions may be displayed in the browser using a user interface control to list the plurality of topic descriptions. A selection of a target topic stack may be received. The target topic stack, target topic description and target plurality of URIs for the topic description may be displayed using the browser.

### BACKGROUND

Vast amounts of personal, public and private information are stored on computers around the world. Much of this information is accessible via internet connections, mobile wireless connections, or similar networking connections. These massive amounts of information may be stored across private servers, public servers, cloud storage, network attached storage system (NAT system), or any number of other electronically accessible storage technologies.

Many pieces of information across these large public and private computer networks may be accessed with a URI (Universal Resource Identifier), URL (Universal Resource Locator), URN (Universal Resource Name) or another linking technology that allows users to view, access or execute digital content. The use of URI's may provide access to individual pieces of information, such as web pages, videos, audio recording, images, text files, spread sheets, executable images, binary data or many other types of information.

### BRIEF DESCRIPTION OF THE DRAWINGS

FIG. 1A illustrates a user interface of a browser that displays a user interface control when recommendation URIs are available according to an example of the present technology.

FIG. 1B illustrates a user interface of a browser that displays a list of recommendation URIs according to an example of the present technology.

FIG. 1C illustrates a user interface of a browser that displays page content associated with a URI selected from the list of recommendation URIs according to an example of the present technology.

FIG. 1D illustrates a user interface of a browser that displays a sub interface that allows a user to save a URI from the list of recommendation URIs to an existing URI stack according to an example of the present technology.

FIG. 1E illustrates a user interface of a browser that displays a sub interface that shows groups and communities related to a recommendation URI on a list of recommendation URIs according to an example of the present technology.

FIG. 2A illustrates a user interface of a browser that displays a user interface control in a tab of the browser when recommendation URIs are available according to an example of the present technology.

FIG. 2B illustrates a user interface of a browser that displays a list of recommendation URIs according to an example of the present technology.

FIG. 3 illustrates a user interface of a browser that displays a user page including a plurality of URI stacks according to an example of the present technology.

FIG. 4 illustrates a system and related operations for finding content related to a URI according to an example of the present technology.

FIG. 5 illustrates a system and related operations for finding and ranking content related to a URI according to an example of the present technology.

FIG. 6 is a flowchart of an example method for finding content related to a URI.

FIG. 7 is a flowchart of another example method for finding content related to a URI.

FIG. 8 is a block diagram of a service provider environment according to an example of the present technology.

FIG. 9 is a block diagram that provides an example illustration of a computing device that may be employed in the present technology.

### DETAILED DESCRIPTION

A technology is described for finding content related to URIs in a browser. For example, a user may use a browser (e.g., a web browsing application) executing on a computing device to access an electronic page associated with a source URI (e.g., a source URL). The computing device may be a desktop computer, laptop computer, mobile cellular device, tablet computer, etc. The browser may include a viewable user interface to display the electronic page associated with the source URI. The source URI associated with the electronic page in the browser may be sent from the browser to a content searching service operating in a service provider environment or on a centralized server. The content searching service may include a query engine that receives the source URI as a query, and the search engine may query the source URI against a data store containing a plurality of URI groupings which form URI stacks. An URI stack is a collection of URIs or URL that a user has collected. When the URI stack has an associated topic description and stack title then it may be considered a topic stack. The content searching service may identify, using the query engine, search result URIs, where URIs included in the search result may be contextually related to the source URI. The search result URIs may reference electronic pages, video, audio, images or any other digital object that may be reference by the URI across a computer network. The content searching service may provide a listing of the search result URIs to the browser, and the user may select certain target URIs from the listing. The selected target URI(s) may be displayed in the browser and/or the certain target URIs may be added to a topic stack created by the user. Alternatively, the search results that are returned may be topic stack which may be accessed in order to access URIs associated with the topic stack.

In one example, the URI groupings that form URI stacks in the data store may be grouped together with a topic description which provides relational context for the URIs. The topic description may include key words or phrases that describe the content associated with the URIs. For example, URIs related to “chamber music” may form a URI grouping and the topic description may include key words, descriptions or phrases related to chamber music to describe the URIs. As another example, URIs related to “ballet” may form a URI grouping and the topic description may include key words or phrases related to ballet to describe the URIs. The URI groupings that form the URI stacks may include 10 individual URIs, 20 individual URIs, 50 individual URIs, and so on. The URI stacks may include various elements, including the topic description, title, the URIs in the URI stacks, the key words and phrases associated with the URIs in the URI stacks, a URI context description, tags, notes on the URIs in the URI stacks, etc.

In one example, the source URI corresponding to the electronic page visited by the user via the browser may be sent from the browser to the content searching service operating in the service provider environment. The content searching service may send the source URI to the search engine, which may perform a search against the data store containing the plurality of URI groupings which form the URI stacks. In other words, when performing the search, the search engine may query the source URI (e.g., the contents of the data object referenced by the URI or reference terms in the URI itself) against the plurality of URI stacks, where each URI stack may include topic descriptions, URIs, key words, tags and phrases that describe the URIs in the URI stack, URI context descriptions, text for context, notes with callouts for a URI, etc. The search engine may produce a search result which may include a plurality of search result URIs or topic stacks. URIs in the search result may be based on the source URI's association with elements of the URI stacks. In other words, when the source URI is similar or related to one or more elements (e.g., URIs, topic descriptions, titles, context descriptions, etc.) of a URI stack, URIs from that URI stack may be provided as search result URIs from the query engine. Thus, the search result URIs may be directly and/or contextually related to the source URI as defined by elements of the URI stacks.

In one example, the browser may receive the search result URIs from the search engine via the content searching service. The browser may display a user interface control indicating that recommendation URIs are available for viewing, and the recommendation URIs may include the search result URIs received from the search engine. For example, the user interface control may be a graphical icon that change colors, blinks, flashes, makes a sound, or otherwise visually or audibly changes to notify the user that the recommendation URIs are available for viewing. In one example, the user interface control may be an icon on a browser plug-in bar. In another example, the user interface control may be an icon on a browser control bar. In yet another example, the user interface control may be an icon on a tab control of a tab containing the source URI. The user interface control may be selected or activated by the user through the user interface. In response to the user interface control being selected or activated, the browser may display a list of the recommendation URIs via the user interface. The browser may receive a selection of a target URI from the list of recommendation URIs presented via the user interface. In response to the selection of the target URI from the list, the browser may display an electronic page associated with the target URI.

In one example, the target URI may be added to a URI stack created by the user. For example, the user may create separate URI stacks corresponding to different interests of the user. For example, the user may create separate URI stacks for music, travel, history, pop culture, etc. The URI stacks may be accessible to the user for viewing when the user has a desire to visit the URI stacks and the URIs included in the URI stacks. In addition, the user may share the URI stacks among other users or certain groups of users, such as friend groups, family members, work colleagues, etc.

In one example, the recommendation URIs may be identified based on the electronic page(s) viewed by the user via the browser. The URI of the electronic pages being viewed and/or its contents may be used as the query for finding related URIs. In addition, the recommendation URIs may be identified based on URIs that are included in URI stack(s) created or saved by the user. The URIs included in the URI stack(s) may be marked or tagged as “favorite” URIs of the user. Therefore, the recommendation URIs may be related to both the electronic page(s) viewed by the user and “favorite” URIs that have been previously added to URI stack(s) created by the user, thereby enabling the recommendation URIs to be specific to the browsing behavior and interests of the user.

In a specific example, a user may visit an electronic page related to 17^{th} century classical artists. The browser may automatically send a source URI associated with the electronic page to the content searching service without explicit instructions or any intervention by the user interacting with the browser. A search query involving the source URI may be performed. For example, the source URI corresponding to 17^{th} century classical artists may be compared to a plurality of URI stacks, each containing elements related to URIs corresponding to electronic pages about 17^{th} century classical artists, topic descriptions related to 17^{th} century classical artists, etc. The browser may receive search result URIs relating to 17^{th} century classical artists. When the search result URIs are received, the browser may visually change a user interface control (e.g., an icon on a browser plug-in bar, a browser control bar, a tab control of a browser, etc.) to indicate that recommendation URIs related to 17^{th} century classical artists are available for viewing. The user may select the user interface control to view a list of the recommendation URIs, or the user may add certain target URIs to URI stacks created by the user. As a result, the user may be provided with URIs of electronic pages that include information that may be of interest to the user, based on the URI and related content the user is currently viewing using the browser.

As previously mentioned, a vast amount of data may be stored across a massive number of servers or other storage systems across the world, and one side effect is that this large amount of digital information is becoming more disorganized over time at a personal level, a company level, and even a global level. As time passes, nearly every aspect of our lives and the actions we take are recorded electronically. However, digital clutter and digital disorganization when accessing valuable data becomes more apparent every day. Even the meaning of data spread across many locations may be difficult to discern, and meaningful data for a specific topic becomes more difficult to find.

For example, digital clutter often means that finding a significant amount of useful and focused information on a specific topic can often be quite difficult. A researcher may find one or two links or electronic pages on a specific topic by using a search engine. However, finding a significant amount of information on a particular topic, especially technical topics, can be quite difficult. Examples of highly technical topics where there is value in find relevant resources on the topic may include: mechanical device repair, electronic device repair, vocational training, detailed hobbies and other areas where a single link or a single line answer from a search engine may not be enough to satisfy what the researcher is trying to find or become a greater expert in.

Another example of electronic disorganization is that every person with an electronic device has data spread across a wide variety of storage locations. For example, users may have data that is accessible on a local network, in a private cloud, in a public cloud, through a web application, in a customer application, in a vendor application, at an internet website, etc. Such large amounts of digital data can be difficult to organize and even reference again once the data has been created by or on behalf of a user. Further, the large amounts of information available on a vast number of servers and on the internet have become increasingly disorganized as more data is created and more time passes by. The amount of data that has become cluttered and disorganized is growing as time passes in the digital age and the ability to find desired information within that massive amount of data is not improving.

The present technology provides a platform for minimizing or reducing the amount of digital clutter and disorganization. For example, the platform may allow users to create topic stacks or URI stacks corresponding to certain subjects or topics of interest to the user. The topic stacks may allow the user to easily keep track of a large number of URIs pertaining to a specific topic. The user may browse web content and when arriving upon web content that is of particular interest, the user may add a corresponding URI or URL to a certain topic stack. The topic stacks may be curated by the user, such that the user may add or remove URIs from the topic stacks accordingly. In another example, the user may easily add new URIs to topic stacks when browsing web content based on recommendation URIs that are automatically presented to the user, thereby allowing the user to view the related URIs and add those related URIs to topic stacks. The recommendation URIs may be related in subject matter, content, terms, or topics to a URI of an electronic page that is currently being viewed by the user. In a further example, the user may share topic stacks with other users, such as friends, family members, colleagues, etc. Similarly, the user may view and access topic stacks shared by others, thereby creating a platform that allows users to learn various topics and efficiently organize information related to those topics.

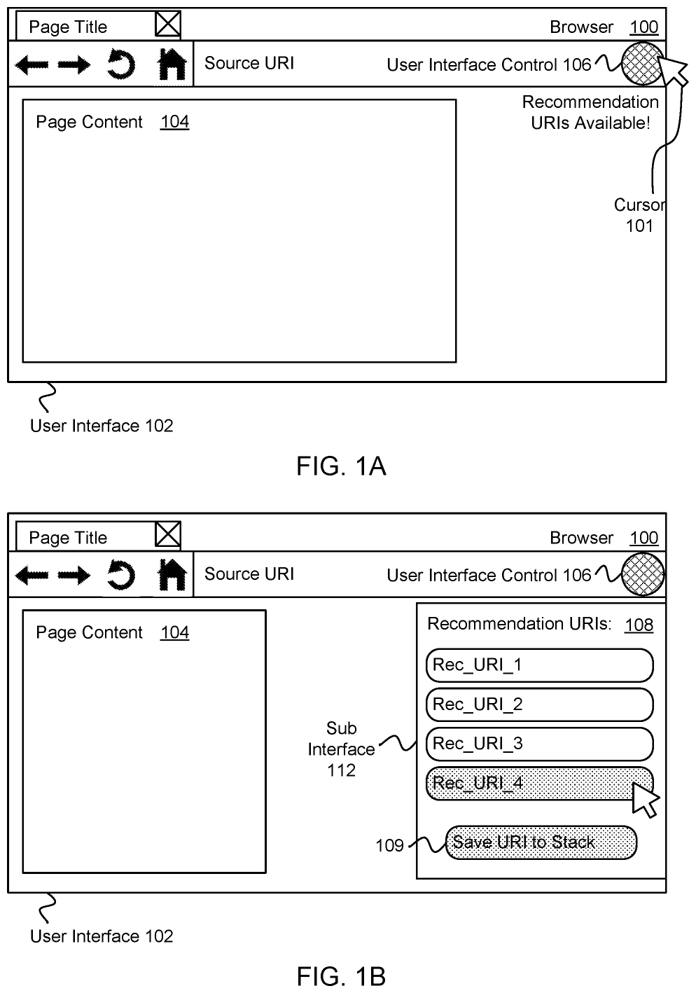

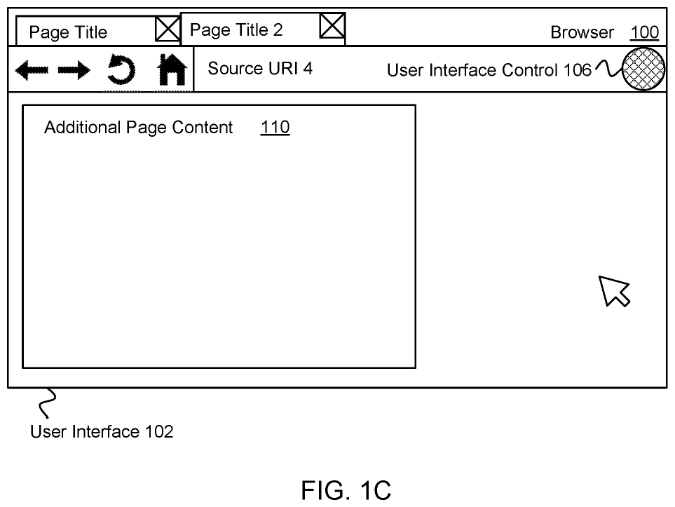

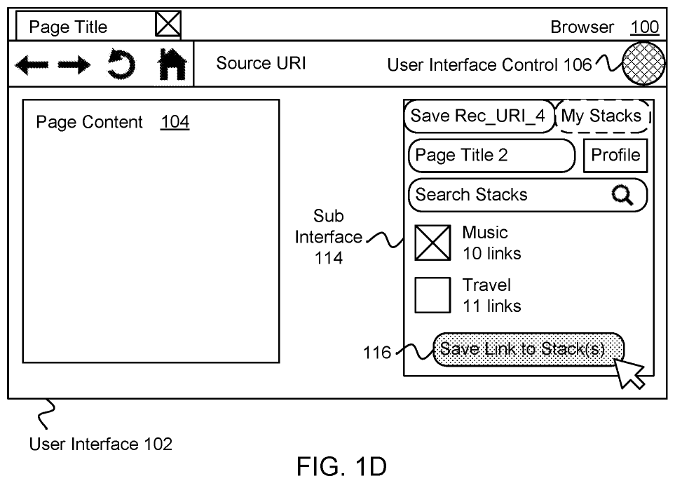

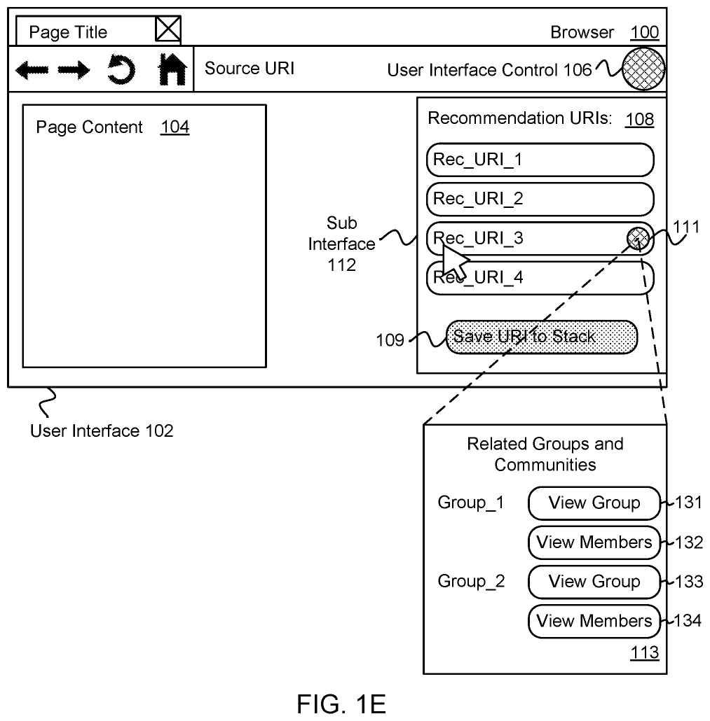

FIG. 1A illustrates an example of a user interface 102 of a browser 100 that displays a change in a user interface control 106 when recommendation URIs are available. A user may access an electronic page associated with a source URI 108, where the electronic page may include page content 104. In some cases, the user interface control 106 may be a graphical icon that changes colors, blinks, flashes or otherwise visually changes when the recommendation URIs are available. The recommendation URIs may be similar to or in some way related to the source URI that is currently being accessed by the user. For example, the recommendation URIs may cover a similar topic, be topically related, have similar key words, or have similar informational content as compared to the source URI that is currently being accessed. The user may select the user interface control 106 using a cursor 101 in order to view the recommendation URIs.

In one example, the user may be unaware that the browser is facilitating a process for determining the recommendation URIs. For example, the user may simply access the page content 104 via the user interface 102, and in the background, the browser 100 may send the source URI 108 to a content searching service in a service provider environment. The content searching service may run a search query, using the source URI 108, against a data store of URI groupings which form URI stacks, and the content searching service may return search result URIs to the browser. When the browser receives the search result URIs, the browser may activate the user interface control 106 to indicate to the user that recommendation URIs are available for viewing, where the recommendation URIs are the search result URIs returned from the content searching service. Alternatively, the search results that are returned may be topic stack which may be accessed in order to further access URIs associated with the topic stack.

FIG. 1B illustrates an example of a user interface 102 of a browser 100 that displays a list of recommendation URIs 108. For example, the list of recommendation URIs 108 may be displayed via a sub interface 112 in response to a user selection of a user interface control 106. The sub-interface may be a list box, a drop-down menu or another listing type of user interface. In this example, the list of recommendation URIs 108 may include four separate URIs that are related to a source URI. The source URI may be associated with electronic page content 104 that is currently being displayed via the user interface 102. The sub interface 112 may allow a user to select one of the recommendation URIs, as well as a button 109 to save the selected URI to a topic stack associated with the user.

FIG. 1C illustrates an example of a user interface 102 of a browser 100 that displays additional page content 110 associated with a URI selected from the list of recommendation URIs 108. The additional page content 110 may be shown in a separate tab of the browser 100. In other words, the page content 104 associated with the source URI may be shown in a first tab of the browser 100, and the additional page content 110 associated with the URI selected from the list of recommendation URIs 108 may be shown in a second tab of the browser 100.

FIG. 1D illustrates an example of a user interface 102 of a browser 100 that displays a sub interface 114 that allows a user to save a URI from the list of recommendation URIs 108 to an existing URI stack which belongs to the user. For example, after selecting a URI from the list of recommendation URIs 108 (as shown in FIG. 1B), the browser 100 may display the sub interface 114 to allow the user to save the URI to a topic stack associated with the user. In this example, the user may have previously created topic stacks related to music and travel, respectively, and the user may save the URI to the topic stack related to music. The sub interface 114 may list the available topic stacks in which the URI can be saved, as well as information about the number of links or URIs in each of the topic stacks. After user selection of the topic stack, the user may select a button 116 shown on the sub interface 114 via the cursor 101 to save the URI or link to the selected topic stack.

FIG. 1E illustrates an example of a user interface 102 of a browser 100 that displays a sub interface 113 that shows groups and communities related to a recommendation URI on a list of recommendation URIs 108. For example, a user may be presented with the list of recommendation URIs 108 based on electronic page content 104 that is currently being displayed via the user interface 102. A recommendation URI (e.g., Rec_URI_3) listing may have an associated user interface control 111 when information about related groups and communities corresponding to that particular recommendation URI is available. The user interface control 111 may be a graphical icon that changes colors, blinks, flashes or otherwise visually changes when the information about related groups and communities corresponding to that particular recommendation URI is available. In one example, when the user moves a cursor 101 over the user interface control 111, the sub interface 113 may be displayed as an overlay on the user interface 102. The sub interface 113 may display the information about related groups and communities corresponding to that particular recommendation URI. For example, the sub interface 113 may include a list of groups or communities that relate to the particular recommendation URI. As a specific example, for a first group, a button 131 to view the first group may be displayed and a button 132 to view the members of the first group may be displayed. Similarly, for a second group, a button 133 to view the second group may be displayed and a button 134 to view the members of the second group may be displayed.

In a further example, the user may create a group or community related to a certain topic and add a URI stack to a created group or community. For example, the user may view the recommendation URI listing, and based on the recommendation URIs included in the listing, the user may create the group and add the recommendation URI to a URI stack and then to the created group. In addition, other users may join the group created by the user. The other users may have an interest in the topic associated with the group. The other users may or may not have created their own URI stacks related to the topic associated with the group.

In yet a further example, the user may join the recommended groups and communities based on a common interest between the user and other members of the groups and communities. The user may be able to post messages, send notifications on favorite URIs or created topic stacks, etc. to other members of a certain group or community. The user may be able to send personal messages to other members of a certain group or community. Further, when the user joins a certain group or community, the user may open a home page that includes a feed of activities performed by the other members in that certain group or community. For example, if another member of the group or community posts a message, likes a URI, creates a topic stack, etc., then a notification may appear in the user's feed for the group or the user's general feed, thereby allowing the user to consume relevant content from other users in the group or community. Further, by joining certain groups and communities, the user may be able to communicate with other members that share a common interest with the user.

In one configuration, a content searching service may run a search query, using a source URI, against a data store of URI stacks associated with a group or community that includes the user or any user selected community. In other words, based on the groups or communities in which the user belongs to or which a user selects, the content searching service may search the URI stacks associated with these groups or communities. For example, the search query may be applied to the group and/or to selected members of the group and the URI stacks associated with the group or the members of the group. As a result, the user may be presented with a recommendation URI listing that is of relevance to the interests of the user because other members of the group or community which the user belongs to or the group which the user selected may have created URI stacks with URIs that are of particular interest to the user.

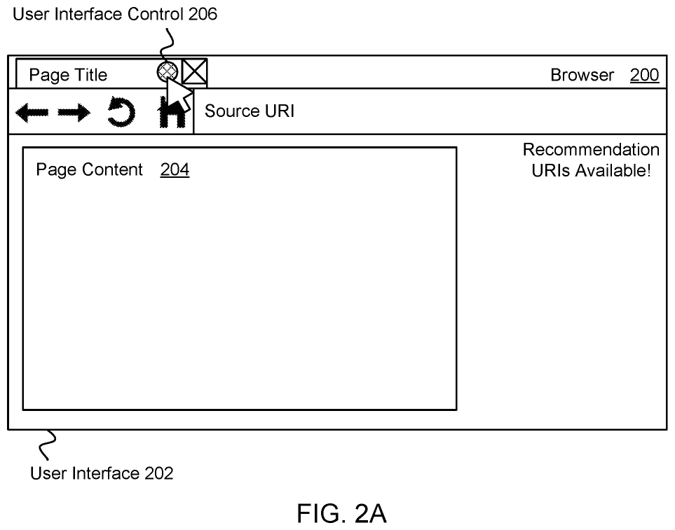

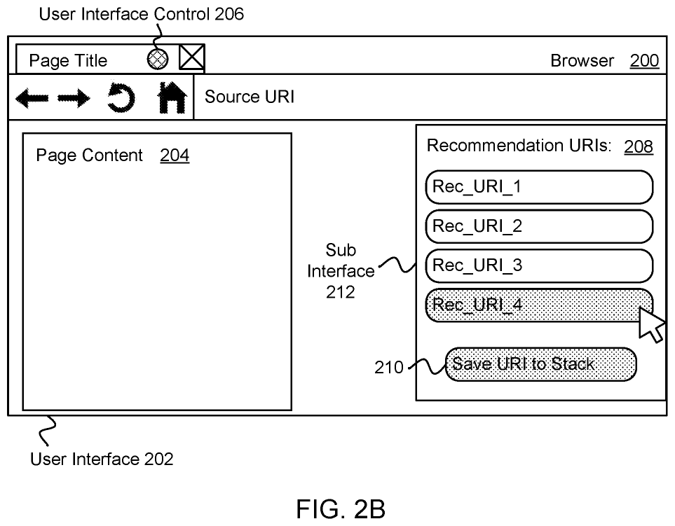

FIG. 2A illustrates an example of a user interface 202 of a browser 200 that displays a change in a user interface control 206 in a tab of the browser 200 when recommendation URIs are available. In this example, the user interface control 206 in the tab of the browser 200 may be a graphical icon that changes colors (e.g., a graphical icon that changes from red to green), blinks, flashes or otherwise visually changes when the recommendation URIs are available, and the user interface control 206 may be selected by a user via a cursor in order to view the recommendation URIs. Alternatively, an audible message, video message or animation may be provided to indicate that recommendation URIs are available.

FIG. 2B illustrates an example of a user interface 202 of a browser 200 that displays a list of recommendation URIs 208. The list of recommendation URIs 208 may be displayed via a sub interface 212 in response to a user selection of a user interface control 206 in a tab of the browser 200. In this example, the list of recommendation URIs 208 may include four separate URIs that are related to a source URI. The source URI may be associated with page content 204 that is currently being displayed via the user interface 202. The sub interface 212 may allow a user to select one of the recommendation URIs, as well as a button 210 to save the selected URI to a topic stack associated with the user.

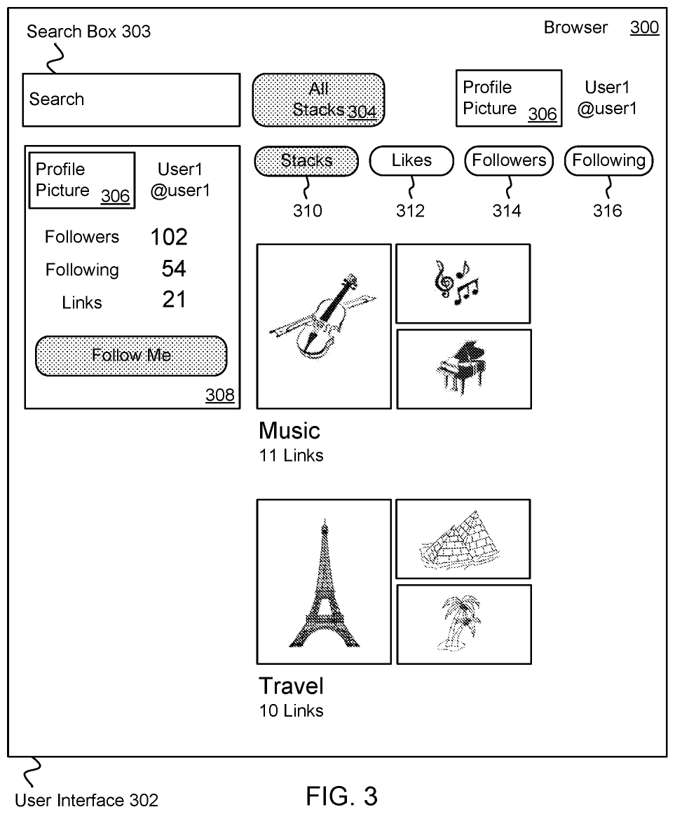

FIG. 3 illustrates an example of a user interface 302 of a browser 300 that displays a plurality of topic stacks associated with or owned by a user. Each topic stack may include a plurality of URIs or links that are of interest to the user, where the URIs and links may be grouped according to a topic. The user interface 302 may include user information 308, which may include a profile picture 306, a user name or user handle, a number of followers for the user, a number of people that are being followed by the user and a total number of links or URIs saved by the user. The user interface 302 may include a search box 303 that allows the user to enter key words or phrases to find URIs or links that are related to a query entered into the search box 303. For example, the user may select a button 304 to perform the search against all topic stacks that have been created by a plurality of users. The user interface 302 may provide search result URIs or links, which may then be added to one of the topic stacks associated with the user. Alternatively, URIs or links that are found via the search box 303 may be added to a newly created topic stack.

In one example, the user interface 302 may include a button 310 to view the topic stacks created by the user, a button 312 to access a list of other users that have liked the topic stacks created by the user, a button 314 to access a list of followers of the user, and a button 316 to access a list of other users that are being followed by the user. In this particular example, the user interface 302 may indicate the user has created two topic stacks, which may include a first topic stack related to music and a second topic stack related to travel. The user interface 302 may include a number of URIs or links that are associated with each topic stack, as well as images to represent each URI or link that is included in the topic stack. Thus, for each topic stack, the user interface 302 may display a mosaic of images to represent the URIs or links that are included in the topic stack. Further, for a given topic stack, a stack creator may leave notes or other users have an ability to leave comments.

In one example, the user interface 302 may show a dashboard of topic stacks created by the user. The topic stacks may include URIs or URL links to electronic pages on the web. The topic stacks may be an aggregation or curation of URIs or URL links on a particular topic.

In the past, when users were interested in learning more about a certain topic, the users may have typed a query into a search engine and then read articles that are related to the query. The users may consume these articles and gain more knowledge about the certain topic, and this increased knowledge may allow the users to enter more refined or detailed queries into the search engine, which may result in articles that are more relevant or of increased quality. Therefore, users may use the internet to learn about specific topics and to increase knowledge on certain topics.

In contrast, the present technology provides a platform to take different pieces of knowledge from around the internet, and aggregate that knowledge into one place under one topic and/or title. For example, a user may spend a large amount of time researching a specific topic and may be knowledgeable about some of the best URIs or links on the internet about that specific topic. The user may use the platform to create a topic stack with a description about this topic and add relevant URIs or links to the topic stack. For example, the user may add 12 links to a certain topic stack and vitamins. The user may have the ability to share all 12 links as one link using the user interface 302. This ability to share knowledge about a certain topic may be useful, as often times a person may intend to send information about a topic to a friend or family member, but either the person does not remember or procrastinates due to the amount of time needed to gather multiple links on the internet. With the present technology, users are able to ‘stack it forward’ and share information with someone that is interested in a particular topic. The user may take all the information that they have aggregated and organized over time and share that information with someone who is interested in consuming that information. As a result, the user that receives a link to the topic stack may consume a list of URIs or links that have already been aggregated and curated for quality, thereby saving them time and energy.

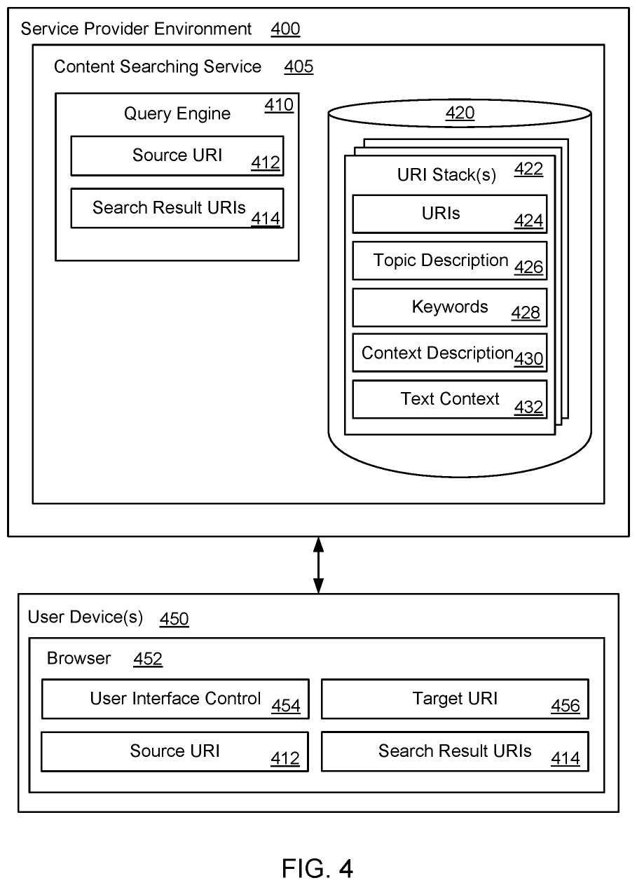

FIG. 4 illustrates an example of a system and related operations for finding content related to a URI. A content searching service 405 operating in a service provider environment 400 may include or communicate with a query engine 410 to generate a plurality of search result URIs 414 related to a source URI 412. More specifically, the query engine 410 may obtain the search result URIs 414 by performing a search using the source URI 412 against a data store 420 accessible to the content searching service 405, where the data store 420 includes a plurality of URI stacks 422. The content searching service 405 may provide the search result URIs 414 to a browser 452 of a user device 450. Alternatively, the search results that are returned may be topic stack which may be accessed in order to access URIs associated with the topic stack.

The browser 452 may receive a selection of a target URI 456 from the search result URIs 414, and the browser 452 may retrieve an electronic page associated with the target URI 456 for display on the user device 450. A user that is visiting the electronic page associated with the source URI 412 may view the electronic page associated with the target URI 456, as the target URI 456 may be similar to the source URI 412 and may be of interest to the user. In addition, the target URI 456 may be added to a URI stack created by the user, which may subsequently be publicly available or shared among other users, such as family members, friends, colleagues, etc.

In one example, the data store 420 in the content searching service 405 may include the URI stack(s) 422. The URI stacks 422 may also be referred to as topic stacks, as the URI stacks 422 may be associated with a certain topic and/or title. Each URI stack 422 may include a plurality of URIs 424. In other words, the plurality of URIs 424 may be grouped together to form the URI stack 422. The plurality of URIs 424 in a given URI stack 422 may be related to a similar topic, theme, subject, category, key word, etc. The URI stack 422 may include a topic description 426. The topic description 426 may provide relational context for the URIs 424 in the URI stack 422 and explain why the URI was added to the topic stack and may explain how the URI is related to the topic stack. The topic description 426 may describe the topic, theme, subject, category, etc. associated with the plurality of URIs 424 in the URI stack 422. The URI stack 422 may further include keywords 428 or tags to describe the nature of the plurality of URIs 424 in the URI stack 422. The URI stack 422 may further include a context description 430 and/or text context 432 to describe the nature of the plurality of URIs 424 in the URI stack 422.

In one example, the browser 452 of the user device 450 may display an electronic page associated with the source URI 412. The browser 452 may display the electronic page in a viewable user interface of the browser 452. For example, the electronic page may be a website, an application, a video, a podcast or another electronic object being accessed by a user of the user device 450. The browser 452 may send the source URI 412 to the content searching service 405. More specifically, the browser 452 may send the source URI 412 as a search query to the content searching engine 405. The content searching service 405 may receive the source URI 412 as the search query, and provide the source URI 412 to the query engine 410. The query engine 410 may perform the search query for the source URI 412 by searching or querying against the data store 420 containing the plurality of URI stacks 422 (or URI groupings which form the URI stacks 422). Thus, by querying against the plurality of URI stacks 422 using the source URI 412, the query engine 410 may compare the source URI 412 against elements of the URI stacks 422 (e.g., the URIs 424, topic descriptions 426, keywords 428, context descriptions 430, title, and/or text context 432) when executing the search query.

The query engine 410 may generate the search result URIs 414 as a search result, where the search result URIs 414 may be related to the source URI 412. For example, the search result URIs 414 may have a similar topic description, keywords, context description, text context, etc. as compared to the source URI 412. The content searching service 405 may provide the search result URIs 414 to the browser 452 of the user device 450. The browser 452 may receive the search result URIs 414, and in response, the browser 452 may display a user interface control 454 to indicate that recommendation URIs corresponding to the search result URIs 414 are available for viewing. In one example, the user interface control 454 may be an icon on a browser plug-in bar. In another example, the user interface control 454 may be an icon on a browser control bar. In yet another example, the user interface control 454 may be an icon on a tab control of a tab containing the source URI 412. In a further example, the user interface control 454 may be an icon on a tab control containing the source URI 412 or a browser control bar that visually changes or provides a notification when the recommendation URIs are available. For example, the user interface control 454 may change colors, start blinking, create a pop-up, generate a sound, etc. when the search result URIs 414 are received from the content searching service 405.

In one example, the user interface control 454 may be activated based on a selection by a user in the browser 452. For example, the user may select or click on the user interface control 454 displayed by the browser 452. In response to the user interface control 454 being activated, the browser 452 may display a list of the search result URIs 414 (i.e., the recommendation URIs). The user may select one of the search result URIs 414 or recommendation URIs on the list via the user interface of the browser 452, where the selected search result URI 414 or recommendation URI may correspond to the target URI 456. The browser 452 may receive the selection of the target URI 456, and the browser 452 may retrieve the electronic page associated with the target URI 456 for display.

In an alternative configuration, the content searching service 405 may receive the source URI 412 as the search query, and provide the source URI 412 to the query engine 410. The query engine 410 may perform the search query by searching a plurality of topic stacks, which may correspond to the plurality of URI stacks 422, where individual topic stacks may be described using the topic description 426. The query engine 410 may identify a plurality of topic descriptions 426 for topic stacks, where the topic descriptions 426 may be identified from topic descriptions 426 related to the search query, and the topic descriptions 426 may be contextually related to the source URI 412. The content searching service 405 may provide a list of the topic descriptions 426 and corresponding target stacks to the browser 452 for display. The browser 452 may receive a selection of a target topic stack from the list, and in response, the browser 452 may display the target topic stack, a corresponding target topic description and corresponding target URIs for the topic description.

The user device 450 may comprise a computer system that is embodied in the form of a desktop computer, a laptop computer, mobile devices, cellular telephones, smartphones, network-enabled televisions, tablet computer systems, or other devices with like capability.

The various processes and/or other functionality contained within the service provider environment 400 may be executed on one or more processors that are in communication with one or more memory modules. The service provider environment 400 may include a number of computing devices that are arranged, for example, in one or more server banks or computer banks or other arrangements. The computing devices may support a computing environment using hypervisors, virtual machine managers (VMMs) and other virtualization software.

The term “data store” may refer to any device or combination of devices capable of storing, accessing, organizing and/or retrieving data, which may include any combination and number of data servers, relational databases, object oriented databases, cluster storage systems, data storage devices, data warehouses, flat files and data storage configuration in any centralized, distributed, or clustered environment. The storage system components of the data store may include storage systems such as a SAN (Storage Area Network), cloud storage network, volatile or non-volatile RAM, optical media, or hard-drive type media. The data store may be representative of a plurality of data stores as can be appreciated.

The content searching service 405 and the user device 450 may communicate via a network. The network may include any useful computing network, including an intranet, the Internet, a localized network, a wide area network, a wireless data network, or any other such network or combination thereof. Components utilized for such a system may depend at least in part upon the type of network and/or environment selected. Communication over the network may be enabled by wired or wireless connections and combinations thereof.

FIG. 4 illustrates that certain processing modules may be discussed in connection with this technology and these processing modules may be implemented as computing services. In one example configuration, a module may be considered a service with one or more processes executing on a server or other computer hardware. Such services may be centrally hosted functionality or a service application that may receive requests and provide output to other services or consumer devices. For example, modules providing services may be considered on-demand computing that are hosted in a server, virtualized service environment, grid or cluster computing system. One or more API(s) may be provided for each module to enable a second module to send requests to and receive output from the first module. Such APIs may also allow third parties to interface with the module and make requests and receive output from the modules. While FIG. 4 illustrates an example of a system that may implement the techniques above, many other similar or different environments are possible. The example environments discussed and illustrated above are merely representative and not limiting.

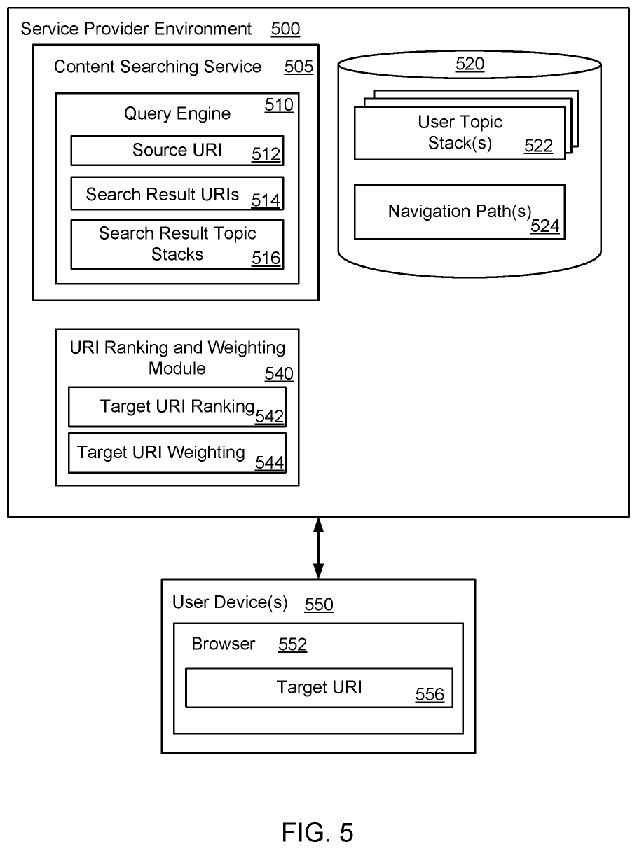

FIG. 5 illustrates an example of a system and related operations for finding and ranking content related to a URI. A content searching service 505 in a service provider environment 500 may include a query engine 510. The query engine 510 may receive a source URI 512 that is being displayed on a browser 552 of a user device 550, and the query engine 510 may perform a query of the source URI 512 against a data store (as shown in FIG. 4) containing a plurality of URI stacks or topic stacks. The content searching service 505 may send a list of search result URIs 514 to the browser 552, and the browser 552 may display the list of search result URIs 514 via a user interface of the user device 550. The browser 552 may receive a selection of a target URI 556 from the list, and in response, the browser 552 may display an electronic page associated with the target URI 556.

In an alternative example, the content searching service 505 may send a list of search result topic stacks 516 to the browser. The browser 552 may receive a selection of a target topic stacks from the list, and in response, the browser 552 may display a list of target URIs 556 associated with the target topic stack.

In one example, the service provider environment 500 may include a data store 520 that stores a plurality of user topic stacks 522. The user topic stacks 522 may be associated with a plurality of individual users. For example, an individual user may store certain user topic stacks 522 related to topics that are of interest to the user. Each user topic stack 522 may include a plurality of URIs, a topic description related to the URIs, keywords or tags that describe a nature of the URIs, and a context description of the URIs.

The data store 520 can further include navigation paths 524 corresponding to a plurality of users. An individual navigation path 524 associated with a particular user can track a navigation path 524 of the user through search result topic stacks 516 and search result URIs 514 presented to the user. For example, the navigation path 524 can include an indication of which URIs and topic stacks were presented to the user, as well as which URIs and topic stacks were selected by the user. These selections of URIs or topic stacks may be used to modify the rankings of the URIs or topic stacks with respect to topics in the overall system.

In one example, the browser 552 may receive the search result topic stacks 516 containing the search result URIs 514 from the content searching service 505. In this example, the navigation paths 524 created by a user may correspond to other users' navigation paths that have related interests. The search result URIs 514, the search result topic stacks 516 as defined by other user's similar navigation paths 524 may be displayed via a user interface of the user device 550, and the user may select at least one of: the search result URIs 514, the search result topic stacks 516 and/or for display.

In one example, a navigation path 524 of the user may be tracked through the search result URIs 514 and the search result topic stacks 516 selected by the user. URIs and topic stacks may be presented to the user based on the user topic stacks 522 associated with other users with topical interests or navigation paths that are similar to the user. In another example, the navigation path 524 of the user may be tracked, and URIs and topic stacks based on the user topic stacks 522 created by other users with topical interests that are similar to the user may be displayed.

In one configuration, the service provider environment 500 may include a URI ranking and weighting module 540 to determine a target URI ranking 542 and a target URI weighting 544 associated with the target URI 556. In one example, the URI ranking and weighting module 540 may increase the target URI ranking 542 associated with the target URI 556 selected by a user using the browser 552, where the target URI ranking 542 may represent a ranking of the target URI 556 with respect to a topic associated with the source URI 512. In another example, the URI ranking and weighting module 540 may determine the target URI weighting 544 based on the last target URI 556 that is selected by the user. For example, the last target URI 556 that is selected may be used for weighting of the target URI 556 with respect to the topic of the source URI 512 because the last target URI selected will be assumed to satisfy the user's interest related to the topic being viewed and searched. In another example, the target URI 556 that is selected last and fulfills a user's search interest may have an increased weighting for the topic of the source URI 512, whereas target URIs 556 that are selected earlier in time may have a decreased weighting for the topic of the source URI 512.

In one example, the target URI 556 may be added to a user topic stack 522 via the user interface of the user device 550. For example, the user using the user device 550 may have previously created the user topic stack 522 that is stored on the data store 520, and upon being presented with the target URI 556, the user may provide instructions to add the target URI 556 to the user topic stack 522. In this example, the URI ranking and weighting module 540 may increase the target URI weighting 544 of the target URI 556 that is added to the user topic stack 522, where the target URI weighting 544 may be increased for the topic of the source URI 512.

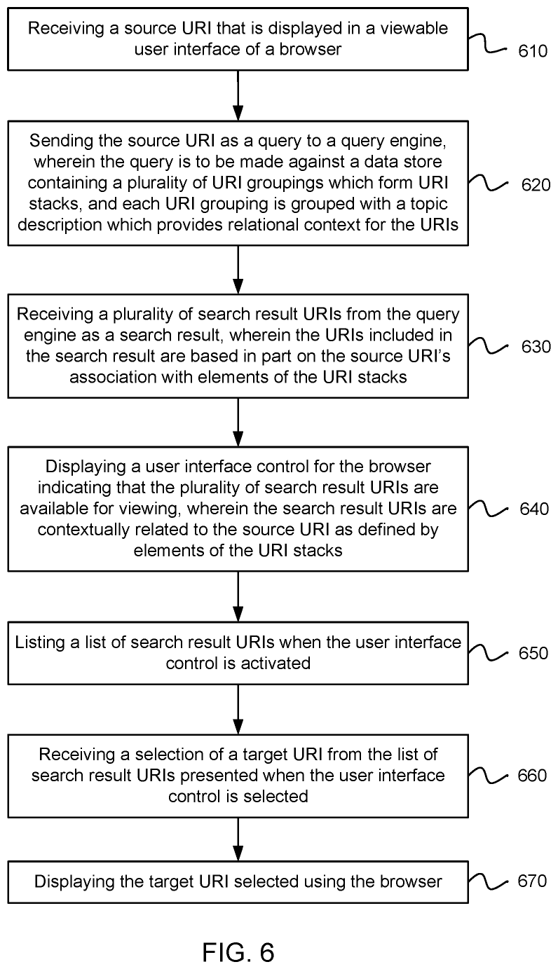

FIG. 6 illustrates an example of a method for finding content related to a URI. A source URI that is displayed in a viewable user interface of a browser may be received at the browser, as in block 610. The source URI may be associated with an electronic page having a topic or related to a subject that is of interest to a user of the browser.

The source URI may be sent as a query to a query engine, as in block 620. The query engine may be used by a content searching service operating in a service provider environment. The query may be made against a data store containing a plurality of URI groupings which form URI stacks. Each URI grouping may be grouped with a topic description which provides relational context for the URIs.

A plurality of search result URIs may be received from the query engine as a search result, as in block 630. The URIs included in the search result may be based in part on the source URI's association with elements of the URI stacks. In one example, the plurality of search result URIs returned may be related to the query because key words of the query are related to the topic description or text content of the URIs. In another example, the search result URIs returned may be identified as being related to a query by using a URI context description provided by a user when a URI is added to a URI stack, where the URI context description may provide a reason the URI is in the stack. In yet another example, the elements of a URI stack may include a topic description, URIs in the URI stacks, keywords or tags associated with the URIs in URI stacks, a URI context description and/or text content of the URIs in the URI stacks.

In one configuration, the search results received from submitting the source URI may be URI stacks or topic stacks. The user may view the list of URI stacks or topic stacks (instead of URI links) and then click on an image representing a URI stack. The URI stack may then be opened and the URIs in the URI stack may be accessed.

A user interface control may be displayed for the browser indicating that the plurality of search result URIs are available for viewing, as in block 640. The search result URIs may be contextually related to the source URI as defined by elements of the URI stacks. In one example, the user interface control may be an icon on a browser plug-in bar. In another example, the user interface control may be an icon on a browser control bar. In yet another example, the user interface control may be an icon on a tab control of a tab containing the source URI in the browser. In a further example, the user interface control may be an icon on a tab control containing the source URI or a browser control bar that visually changes when a recommendation URI is available.

The browser may display a list of search result URIs when the user interface control is activated, as in block 650. In one example, the browser may indicate that at least one related URI is available for a source URI, where the browser may provide the indication using the user interface control in the browser that is a graphical icon. In one example, the list of search result URIs may be displayed as an overlay, using a plug-in, using a sidebar of the browser, using a modal window, using a separate tab or another graphical user interface with respect to the electronic page associated with the source URI.

A selection of a target URI from the list of search result URIs presented may be received when the user interface control is selected, as in block 660. For example, the user of the browser may select the target URI from the list of search result URIs via the viewable user interface of the browser.

The target URI selected may be displayed using the browser, as in block 670. The target URI may be related in content, subject matter, etc. as compared to the source URI. Therefore, the user that is viewing the source URI may be presented with the target URI, where the target URI may be additional content that is potentially of interest to the user.

In one example, a ranking of the target URI selected using the browser may be increased, where the ranking may represent a ranking of the URI with respect to a topic associated with the source URI. In another example, the plurality of search result URIs related to the source URI may be presented and a navigation path through related URIs and topic stacks may be selectable by a user, where the last URI that is selected may be used for weighting of the URI with respect to the topic of the source URI. For example, the last URI selected may have additional weight added to the URI with respect to the initial topic.

In one example, the target URI may be added to a topic stack created by a user. Further, a weighting of the target URI that is added to a user's stack may be increased, where the weighting of the target URI may be increased for the topic of the source URI. In other words, target URIs that are actually added to user stacks may be indicative of being of increased quality, so in this case, the weighting of the target URI may be increased for the topic of the source URI. In another example, the URI that is selected last and fulfills a user's search interest may have an increased weighting for the topic of the source URI.

In one example, a navigation path of a user may be tracked through URIs and/or topic stacks presented to the user, and the browser may display URIs and topic stacks based on other users' navigation paths that are similar to the user. In another example, a navigation path of a user may be tracked through URIs and topic stacks presented to the user, and the browser may display URIs and topic stacks based on topic stacks created by users with topical interests that are similar to the user.

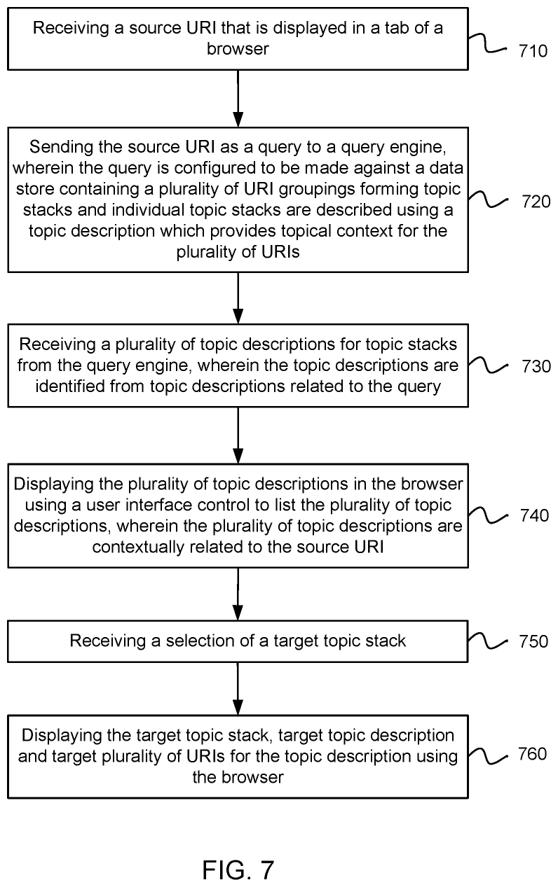

FIG. 7 illustrates an example of a method for finding content related to a URI. A source URI that is displayed in a tab of a browser may be received at the browser, as in block 710. The source URI may be associated with an electronic page having a topic or related to a subject that is of interest to a user of the browser.

The source URI may be sent as a query to a query engine, as in block 720. The query may be made against a data store containing a plurality of URI groupings forming topic stacks. Further, individual topic stacks may be described using a topic description which provides topical context for the plurality of URIs.

A plurality of topic descriptions and topic stacks may be received from the query engine, as in block 730. The topic descriptions may be identified from topic descriptions related to the query. In one example, the topic stacks received may be related to the query, where key words of the query are related to the topic description of topic stacks, title of the topic stack, content of the plurality of URIs in the topic stacks and/or a URI context description.

The plurality of topic descriptions may be displayed in the browser using a user interface control to list the plurality of topic descriptions, as in block 740. The plurality of topic descriptions may be contextually related to the source URI. In one example, the user interface control may be an icon on browser plug-in interface or an icon on a browser control bar. In another example, the user interface control may be an icon on a tab control containing the source URI. In yet another example, the user interface control may be an icon on a browser control bar that changes color when a topic stack recommendation is available. In a further example, the browser may indicate that a topic stack recommendation is available for a source URI using the user interface control in the browser that is a graphical icon.

A selection of a target topic stack may be received at the browser, as in block 750. For example, the user of the browser may select the target topic stack via a viewable user interface of the browser.

The target topic stack, target topic description and target plurality of URIs for the topic description may be displayed using the browser, as in block 760. The target topic stack, target topic description and target plurality of URIs for the topic description may be related in content, subject matter, etc. as compared to the source URI. Therefore, the user that is viewing the source URI may be presented with the target topic stack, target topic description, target topic title, and/or target plurality of URIs for the topic description, which may provide additional content that is potentially of interest to the user.

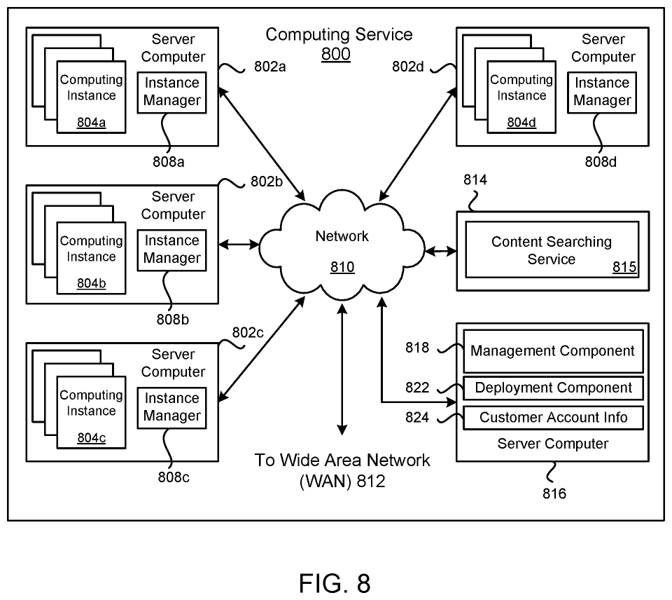

FIG. 8 is a block diagram illustrating an example computing service 800 or service provider environment that may be used to execute and manage a number of computing instances 804a-d upon which the present technology may execute. In particular, the computing service 800 depicted illustrates one environment in which the technology described herein may be used. The computing service 800 may be one type of environment that includes various virtualized service resources that may be used, for instance, to host computing instances 804a-d.

The computing service 800 may be capable of delivery of computing, storage and networking capacity as a software service to a community of end recipients. In one example, the computing service 800 may be established for an organization by or on behalf of the organization. That is, the computing service 800 may offer a “private cloud environment.” In another example, the computing service 800 may support a multi-tenant environment, wherein a plurality of customers may operate independently (i.e., a public cloud environment). Generally speaking, the computing service 800 may provide the following models: Infrastructure as a Service (“IaaS”), Platform as a Service (“PaaS”), and/or Software as a Service (“SaaS”). Other models may be provided. For the IaaS model, the computing service 800 may offer computers as physical or virtual machines and other resources. The virtual machines may be run as guests by a hypervisor, as described further below. The PaaS model delivers a computing platform that may include an operating system, programming language execution environment, database, and web server.

Application developers may develop and run their software solutions on the computing service platform without incurring the cost of buying and managing the underlying hardware and software. The SaaS model allows installation and operation of application software in the computing service 800. End customers may access the computing service 800 using networked client devices, such as desktop computers, laptops, tablets, smartphones, etc. running web browsers or other lightweight client applications, for example. Those familiar with the art will recognize that the computing service 800 may be described as a “cloud” environment.

The particularly illustrated computing service 800 may include a plurality of server computers 802a-d. The server computers 802a-d may also be known as physical hosts. While four server computers are shown, any number may be used, and large data centers may include thousands of server computers. The computing service 800 may provide computing resources for executing computing instances 804a-d. Computing instances 804a-d may, for example, be virtual machines. A virtual machine may be an instance of a software implementation of a machine (i.e. a computer) that executes applications like a physical machine. In the example of a virtual machine, each of the server computers 802a-d may be configured to execute an instance manager 808a-d capable of executing the instances. The instance manager 808a-d may be a hypervisor, virtual machine manager (VMM), or another type of program configured to enable the execution of multiple computing instances 804a-d on a single server. Additionally, each of the computing instances 804a-d may be configured to execute one or more applications.

A server 814 may be reserved to execute software components for implementing the present technology or managing the operation of the computing service 800 and the computing instances 804a-d. For example, the server 814 or computing instance may execute a content searching service 815 operable to find content through topic stacks and URIs in the topic stacks which are related to a uniform resource identifier (URI). The content searching service 815 may receive a source URI that is displayed in a viewable user interface of a browser. The content searching service 815 may send the source URI as a query to a query engine, where the query may be made against a data store containing a plurality of URI groupings which form URI stacks, and each URI grouping may be grouped with a topic description and other context identifiers which provide relational context for the URIs. The content searching service 815 may receive a plurality of search result URIs from the query engine as a search result, where the URIs included in the search result may be based in part on the source URI's association with the topic stack, the context identifiers and/or the elements of the URI stacks. The content searching service 815 may provide the plurality of search result URIs to the browser, where the search result URIs may be contextually related to the source URI as defined by context elements or context identifiers of the URI stacks.

A server computer 816 may execute a management component 818. A customer may access the management component 818 to configure various aspects of the operation of the computing instances 804a-d purchased by a customer. For example, the customer may setup computing instances 804a-d and make changes to the configuration of the computing instances 804a-d.

A deployment component 822 may be used to assist customers in the deployment of computing instances 804a-d. The deployment component 822 may have access to account information associated with the computing instances 804a-d, such as the name of an owner of the account, credit card information, country of the owner, etc. The deployment component 822 may receive a configuration from a customer that includes data describing how computing instances 804a-d may be configured. For example, the configuration may include an operating system, provide one or more applications to be installed in computing instances 804a-d, provide scripts and/or other types of code to be executed for configuring computing instances 804a-d, provide cache logic specifying how an application cache is to be prepared, and other types of information. The deployment component 822 may utilize the customer-provided configuration and cache logic to configure, prime, and launch computing instances 804a-d. The configuration, cache logic, and other information may be specified by a customer accessing the management component 818 or by providing this information directly to the deployment component 822.

Customer account information 824 may include any desired information associated with a customer of the multi-tenant environment. For example, the customer account information may include a unique identifier for a customer, a customer address, billing information, licensing information, customization parameters for launching instances, scheduling information, etc. As described above, the customer account information 824 may also include security information used in encryption of asynchronous responses to API requests. By “asynchronous” it is meant that the API response may be made at any time after the initial request and with a different network connection.

A network 810 may be utilized to interconnect the computing service 800 and the server computers 802a-d, 816. The network 810 may be a local area network (LAN) and may be connected to a Wide Area Network (WAN) 812 or the Internet, so that end customers may access the computing service 800. In addition, the network 810 may include a virtual network overlaid on the physical network to provide communications between the servers 802a-d. The network topology illustrated in FIG. 8 has been simplified, as many more networks and networking devices may be utilized to interconnect the various computing systems disclosed herein.

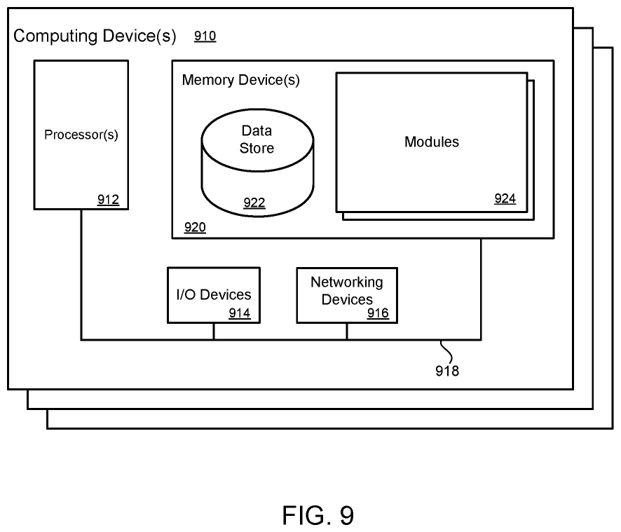

FIG. 9 illustrates a computing device 910 on which modules of this technology may execute. A computing device 910 is illustrated on which a high-level example of the technology may be executed. The computing device 910 may include one or more processors 912 that are in communication with memory devices 920. The computing device may include a local communication interface 918 for the components in the computing device. For example, the local communication interface may be a local data bus and/or any related address or control busses as may be desired.

The memory device 920 may contain modules 924 that are executable by the processor(s) 912 and data for the modules 924. The modules 924 may execute the functions described earlier. A data store 922 may also be located in the memory device 920 for storing data related to the modules 924 and other applications along with an operating system that is executable by the processor(s) 912.

Other applications may also be stored in the memory device 920 and may be executable by the processor(s) 912. Components or modules discussed in this description that may be implemented in the form of software using high programming level languages that are compiled, interpreted or executed using a hybrid of the methods.

The computing device may also have access to I/O (input/output) devices 914 that are usable by the computing devices. An example of an I/O device is a display screen that is available to display output from the computing devices. Other known I/O device may be used with the computing device as desired. Networking devices 916 and similar communication devices may be included in the computing device. The networking devices 916 may be wired or wireless networking devices that connect to the internet, a LAN, WAN, or other computing network.

The components or modules that are shown as being stored in the memory device 920 may be executed by the processor 912. The term “executable” may mean a program file that is in a form that may be executed by a processor 912. For example, a program in a higher level language may be compiled into machine code in a format that may be loaded into a random access portion of the memory device 920 and executed by the processor 912, or source code may be loaded by another executable program and interpreted to generate instructions in a random access portion of the memory to be executed by a processor. The executable program may be stored in any portion or component of the memory device 920. For example, the memory device 920 may be random access memory (RAM), read only memory (ROM), flash memory, a solid state drive, memory card, a hard drive, optical disk, floppy disk, magnetic tape, or any other memory components.

The processor 912 may represent multiple processors and the memory 920 may represent multiple memory units that operate in parallel to the processing circuits. This may provide parallel processing channels for the processes and data in the system. The local interface 918 may be used as a network to facilitate communication between any of the multiple processors and multiple memories. The local interface 918 may use additional systems designed for coordinating communication such as load balancing, bulk data transfer, and similar systems.

While the flowcharts presented for this technology may imply a specific order of execution, the order of execution may differ from what is illustrated. For example, the order of two more blocks may be rearranged relative to the order shown. Further, two or more blocks shown in succession may be executed in parallel or with partial parallelization. In some configurations, one or more blocks shown in the flow chart may be omitted or skipped. Any number of counters, state variables, warning semaphores, or messages might be added to the logical flow for purposes of enhanced utility, accounting, performance, measurement, troubleshooting or for similar reasons.

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. The modules may be passive or active, including agents operable to perform desired functions.

The technology described here can also be stored on a computer readable storage medium that includes volatile and non-volatile, removable and non-removable media implemented with any technology for the storage of information such as computer readable instructions, data structures, program modules, or other data. Computer readable storage media include, but is not limited to, RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which can be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media. The term computer readable media as used herein includes communication media.

Reference was made to the examples illustrated in the drawings, and specific language was used herein to describe the same. It will nevertheless be understood that no limitation of the scope of the technology is thereby intended. Alterations and further modifications of the features illustrated herein, and additional applications of the examples as illustrated herein, which would occur to one skilled in the relevant art and having possession of this disclosure, are to be considered within the scope of the description.

Furthermore, the described features, structures, or characteristics may be combined in any suitable manner in one or more examples. In the preceding description, numerous specific details were provided, such as examples of various configurations to provide a thorough understanding of examples of the described technology. One skilled in the relevant art will recognize, however, that the technology can be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements can be devised without departing from the spirit and scope of the described technology.

What is claimed is:

1. A method for finding content related to a uniform resource identifier (URI), comprising:
receiving a source URI that is displayed in a viewable user interface of a browser;
sending the source URI as a query to a query engine, wherein the query is to be made against a data store containing a plurality of URI groupings which form URI stacks, and each URI grouping is grouped with a topic description which provides relational context for the URIs;
receiving a plurality of search result URIs from the query engine as a search result, wherein the URIs included in the search result are based in part on the source URI's association with elements of the URI stacks;
displaying a user interface control for the browser indicating that the plurality of search result URIs are available for viewing, wherein the search result URIs are contextually related to the source URI as defined by elements of the URI stacks;
providing a list of search result URIs when the user interface control is activated;
receiving a selection of a target URI from the list of search result URIs presented when the user interface control is selected; and
displaying the target URI selected using the browser.

2. The method as in claim 1, wherein the plurality of search result URIs returned are related to the query because key words of the query are related to the topic description.

3. The method as in claim 1, wherein the search result URIs returned are identified as being related to a query by using a URI context description provided by a user when a URI is added to a URI stack, wherein the URI context description provides a reason the URI is in the URI stack.

4. The method as in claim 1, further comprising indicating that at least one related URI is available for a source URI using the user interface control in the browser that is a graphical icon.

5. The method as in claim 4, wherein the user interface control is an icon on a browser plug-in bar.

6. The method as in claim 4, wherein the user interface control is an icon on a browser control bar.

7. The method as in claim 4, wherein the user interface control is an icon on a tab control of a tab containing the source URI.

8. The method as in claim 3, wherein the user interface control is an icon on a tab control containing the source URI or a browser control bar that visually changes when a recommendation URI is available.

9. The method as in claim 1, wherein the elements of a URI stack are at least one of: a topic description, URIs in the URI stacks, keywords associated with the URIs in URI stacks, a URI context description, or text content of the URIs in the URI stacks.

10. A method for finding content related to a uniform resource identifier (URI), comprising:
receiving a source URI that is displayed in a tab of a browser;
sending the source URI as a query to a query engine, wherein the query is configured to be made against a data store containing a plurality of URI groupings forming topic stacks and individual topic stacks are described using a topic description which provides topical context for a plurality of URIs;
receiving a plurality of topic descriptions for topic stacks from the query engine, wherein the topic descriptions are identified from topic descriptions related to the query;
displaying the plurality of topic descriptions for topic stacks in the browser using a user interface control to list the plurality of topic descriptions for topic stacks, wherein the plurality of topic descriptions are contextually related to the source URI;
receiving a selection of a target topic stack; and
displaying the target topic stack, target topic description and target plurality of URIs for the topic description using the browser.

11. The method as in claim 10, wherein the topic stacks received are related to the query, based in part on key words of the query being related to at least one of: the topic description of topic stacks, a title of a topic stack, a URI context comment, content of the plurality of URIs in the topic stacks, or a URI description.

12. The method as in claim 10, further comprising indicating that a topic stack recommendation is available for a source URI using the user interface control in the browser that is a graphical icon.

13. The method as in claim 10, wherein the user interface control is at least one of: an icon on browser plug-in interface or an icon on a browser control bar.

14. The method as in claim 12, wherein the user interface control is an icon on a tab control containing the source URI.

15. The method as in claim 12, wherein the user interface control is an icon on a browser control bar that changes color when a topic stack recommendation is available.

16. A system for finding and ranking content related to a uniform resource identifier (URI), comprising:
receiving a source URI that is being displayed in a tab in a browser;
sending the source URI as a query to a query engine, wherein the query is configured to be made against a data store containing a plurality of URI groupings forming topic stacks and each URI grouping is grouped with a topic description which provides context for the URIs in the URI grouping;
receiving a plurality of search result URIs from the query engine, wherein the search result URIs are identified from a topic description that is grouped with the plurality of URIs which are related to the query;
indicating in the browser using a user interface control that the plurality of URIs, which are related to the source URI, are available for viewing;
receiving a selection of a target URI;
displaying the target URI selected using the browser; and
increasing a ranking of the target URI selected using the browser, wherein the ranking represents a ranking of the URI with respect to a topic associated with the source URI.

17. The system as in claim 16, wherein the plurality of search result URIs related to the source URI are presented and a navigation path through related URIs and topic stacks are selectable by a user, wherein a last URI that is selected is used for weighting of the URI with respect to the topic of the source URI.

18. The system as in claim 16, further comprising:
adding the target URI to a topic stack created by a user; and
increasing a weighting of the target URI that is added to a user's stack, wherein the weighting of the target URI is increased for the topic of the source URI.

19. The system as in claim 16, wherein the URI that is selected last and fulfills a user's search interest has an increased weighting for the topic of the source URI.

20. The system as in claim 16, further comprising:
tracking a navigation path of a user through URIs and topic stacks presented to the user; and
displaying URIs and topic stacks based on other users' navigation paths that are similar to the user.

21. The system as in claim 16, further comprising:
tracking a navigation path of a user through URIs and topic stacks presented to the user; and
displaying URIs and topic stacks based on topic stacks created by users with topical interests that are similar to the user.

22. The system as in claim 16, wherein the search result URIs returned are related to the query because key words of the query are related to the topic description or text content of URIs.

23. The system as in claim 16, wherein the search result URIs returned are identified as being related to a query by using URI context descriptions provided by a user when the URI is added to the URI grouping.
